(19) United States
(12) Patent Application Publication
(10) Pub. No.: US 2026/0312655 A1
(43) Pub. Date: Oct. 8, 2026

(54) PERIODIC CHANNEL STATE INFORMATION REPORTING IN A NON-TERRESTRIAL NETWORK

(71) Applicant: QUALCOMM Incorporated, San Diego, CA (US)

(72) Inventors: Bharat SHRESTHA, San Diego, CA (US); Jae Ho RYU, San Diego, CA (US); Chun-Hao HSU, San Jose, CA (US); Xiao Feng WANG, San Diego, CA (US); Changhwan PARK, San Diego, CA (US); Heechoon LEE, San Diego, CA (US); Krishna Chaitanya MUKKERA, San Diego, CA (US)

(21) Appl. No.: 19/578,659

(22) Filed: Mar. 25, 2026

Related U.S. Application Data
(60) Provisional application No. 63/783,129, filed on Apr. 3, 2025.

(51) Int. Cl. H04B 7/06; H04W 76/28

(52) U.S. Cl. CPC H04B 7/0626; H04W 76/28

(57) ABSTRACT

This disclosure provides methods, components, devices and systems for periodic channel state information (CSI) reporting in a non-terrestrial network (NTN). For example, a user equipment (UE) operating in an NTN according to a discontinuous reception (DRX) cycle with CSI masking may determine whether to transmit a CSI report based on a symbol where the CSI report is scheduled and a timing offset for the NTN. For example, UE may determine whether to transmit a CSI report in a symbol of an on-duration of the DRX cycle based on a symbol where the CSI report is scheduled and a timing adjustment of the UE. The UE may transmit the CSI report in a symbol earlier than the scheduled symbol based on the timing adjustment of the UE.

### CROSS REFERENCE

The present application for Patent claims the benefit of U.S. Provisional Patent Application No. 63/783,129 by Shrestha et al., entitled “PERIODIC CHANNEL STATE INFORMATION REPORTING IN A NON-TERRESTRIAL NETWORK,” filed Apr. 3, 2025, assigned to the assignee hereof, and expressly incorporated by reference herein.

### TECHNICAL FIELD

This disclosure relates generally to wireless communication, and more specifically to systems, devices, methods, and techniques associated with periodic channel state information reporting in a non-terrestrial network (NTN).

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a UE is described. The method may include receiving control information indicating that channel state information (CSI) reports are communicated during an on-duration of a discontinuous reception cycle, receiving a timing offset for timing relationships that are associated with a non-terrestrial network (NTN), determining whether to communicate a CSI report in a first symbol associated with the on-duration based on the control information and the timing offset, the first symbol being offset from a second symbol associated with the CSI report, and transmitting the CSI report during the first symbol based on the determination.

A UE for wireless communications is described. The UE may include a processing system that includes processor circuitry and memory circuitry that stores code. The processing system may be configured to cause the UE to receive control information indicating that CSI reports are communicated during an on-duration of a discontinuous reception cycle, receive a timing offset for timing relationships that are associated with an NTN, determine whether to communicate a CSI report in a first symbol associated with the on-duration based on the control information and the timing offset, the first symbol being offset from a second symbol associated with the CSI report, and transmit the CSI report during the first symbol based on the determination.

Another UE for wireless communications is described. The UE may include means for receiving control information indicating that CSI reports are communicated during an on-duration of a discontinuous reception cycle, means for receiving a timing offset for timing relationships that are associated with an NTN, means for determining whether to communicate a CSI report in a first symbol associated with the on-duration based on the control information and the timing offset, the first symbol being offset from a second symbol associated with the CSI report, and means for transmitting the CSI report during the first symbol based on the determination.

A non-transitory computer-readable medium storing code for wireless communications is described. The code may include instructions executable by one or more processors to receive control information indicating that CSI reports are communicated during an on-duration of a discontinuous reception cycle, receive a timing offset for timing relationships that are associated with an NTN, determine whether to communicate a CSI report in a first symbol associated with the on-duration based on the control information and the timing offset, the first symbol being offset from a second symbol associated with the CSI report, and transmit the CSI report during the first symbol based on the determination.

In some examples of the method, UEs, and non-transitory computer-readable medium described herein, the timing offset corresponds to a largest timing adjustment in the NTN.

In some examples of the method, UEs, and non-transitory computer-readable medium described herein, the timing offset corresponds to a timing adjustment associated with the UE.

In some examples of the method, UEs, and non-transitory computer-readable medium described herein, the CSI report may be a periodic CSI report, and the second symbol corresponds to a reporting occasion for the periodic CSI report.

In some examples of the method, UEs, and non-transitory computer-readable medium described herein, the control information includes CSI mask information.

A method for wireless communications by a UE is described. The method may include receiving control information indicating that CSI reports are communicated during an on-duration of a discontinuous reception cycle, receiving a timing offset for timing relationships that are associated with an NTN, determining whether a first symbol satisfies a threshold distance away from a second symbol of the on-duration associated with a CSI report based on the control information and the timing offset, the first symbol being offset from the second symbol, and transmitting the CSI report during the first symbol based on the first symbol satisfying the threshold distance.

A UE for wireless communications is described. The UE may include a processing system that includes processor circuitry and memory circuitry that stores code. The processing system may be configured to cause the UE to receive control information indicating that CSI reports are communicated during an on-duration of a discontinuous reception cycle, receive a timing offset for timing relationships that are associated with an NTN, determine whether a first symbol satisfies a threshold distance away from a second symbol of the on-duration associated with a CSI report based on the control information and the timing offset, the first symbol being offset from the second symbol, and transmit the CSI report during the first symbol based on the first symbol satisfying the threshold distance.

Another UE for wireless communications is described. The UE may include means for receiving control information indicating that CSI reports are communicated during an on-duration of a discontinuous reception cycle, means for receiving a timing offset for timing relationships that are associated with an NTN, means for determining whether a first symbol satisfies a threshold distance away from a second symbol of the on-duration associated with a CSI report based on the control information and the timing offset, the first symbol being offset from the second symbol, and means for transmitting the CSI report during the first symbol based on the first symbol satisfying the threshold distance.

A non-transitory computer-readable medium storing code for wireless communications is described. The code may include instructions executable by one or more processors to receive control information indicating that CSI reports are communicated during an on-duration of a discontinuous reception cycle, receive a timing offset for timing relationships that are associated with an NTN, determine whether a first symbol satisfies a threshold distance away from a second symbol of the on-duration associated with a CSI report based on the control information and the timing offset, the first symbol being offset from the second symbol, and transmit the CSI report during the first symbol based on the first symbol satisfying the threshold distance.

Some examples of the method, UEs, and non-transitory computer-readable medium described herein may further include operations, features, means, or instructions for waking up prior to the on-duration based on a determination that the threshold distance may be satisfied.

### BRIEF DESCRIPTION OF THE DRAWINGS

FIG. 1 shows an example of a wireless communication system.

FIG. 2 shows an example of a signaling diagram that supports periodic channel state information (CSI) reporting in a non-terrestrial network (NTN).

FIG. 3 shows an example of a CSI reporting timeline that supports periodic CSI reporting in an NTN.

FIG. 4 shows an example of a CSI reporting timeline that supports periodic CSI reporting in an NTN.

FIG. 5 shows an example of a process flow that supports periodic CSI reporting in an NTN.

FIG. 6 shows a block diagram of a processing system that supports periodic CSI reporting in an NTN.

FIG. 7 shows a diagram of a system including a device that supports periodic CSI reporting in an NTN.

FIGS. 8 and 9 show flowcharts illustrating methods that support periodic CSI reporting in an NTN.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, a user equipment (UE) configured to operate according to a discontinuous reception (DRX) cycle may be configured for channel state information (CSI) masking, where the UE is configured to only report CSI if the UE is in an on-duration of the DRX cycle. With current techniques for CSI masking, if the UE is scheduled to transmit a CSI report to a network entity in a current symbol, n, the UE may not transmit the CSI report if that symbol is not within the on-duration of the DRX cycle. Current techniques for CSI masking are supportable in a terrestrial network, where a round trip time of signals between the UE and the network entity are relatively small. In terrestrial networks, a timing adjustment applied by the UE to uplink signaling, including the CSI report, may be relatively small due to a negligible round-trip time to the network entity.

In a non-terrestrial network (NTN), downlink timing and uplink timing may not be aligned because the round trip time for signals communicated between the UE and the network entity may be relatively large. To account for the larger round trip time, an uplink timing may be shifted from downlink timing by a timing adjustment of a UE operating in the NTN. For example, if a UE has a timing adjustment of five symbols, an uplink signal transmitted in a second symbols may be received at an NTN network entity in a seventh symbol. In an NTN, the timing adjustment of the UE may be very large, for example multiple symbols, slots, or frames, due to propagation delay from the UE to the NTN network entity (e.g., a satellite). The NTN network entity may not be aware of an exact location of each UE and thus may not be aware of a timing adjustment for each UE. Uplink scheduling may be based on logical downlink symbols, for example according to timing of the network entity. In some examples, the network entity may indicate a timing offset corresponding to a largest timing adjustment of a UE in the NTN for some timing alignment. Current techniques for CSI masking may not be supported for an NTN. For example, if the UE transmits the CSI report when symbol n occurs according to timing of the NTN network entity (e.g., based on the logical downlink symbol), the CSI report may arrive late at the network entity due to the timing adjustment of the UE. If the UE transmits the CSI report when symbol n occurs according to timing of the UE, the NTN network entity may be unable to allocate resources for the CSI report, as the NTN network entity may not be aware of the timing adjustment of the UE and may not be aware which symbol to use to allocate the resources for the CSI report.

Aspects of the subject matter described in this disclosure relate to periodic CSI reporting in an NTN. In some examples, a UE operating in an NTN according to a DRX cycle with CSI masking may determine whether to transmit a CSI report based on a logical symbol, n, and a timing offset for the NTN. For example, an NTN network entity may configure a timing offset, Koffset, based on a largest timing adjustment of a UE in the NTN. If a UE is configured to transmit a CSI report in symbol n according to network-side timing, and symbol n−Koffset is in an on-duration of a DRX cycle of the UE, the UE may transmit the CSI report in symbol n−Koffset. For example, the UE may determine whether symbol n−Koffset is within the on-duration of the DRX cycle of the UE. If symbol n−Koffset is within the on-duration of the DRX cycle, the UE may transmit the CSI report in symbol n−Koffset. Otherwise, the UE may not transmit the CSI report.

Additional techniques for CSI reporting in an NTN are described. For example, a UE may wake up early from a DRX sleep state to transmit a CSI report based on a symbol, n, that the CSI report is scheduled for (e.g., according to network-side timing) and a timing adjustment of the UE. For example, an NTN network entity may schedule (e.g., expect to receive) a CSI report in a symbol n that occurs in an on-duration of a DRX cycle of the UE. The UE may wake up earlier than a scheduled start of the on-duration of the DRX cycle based on a timing adjustment of the UE to transmit the CSI report. If a timing adjustment of the UE for communications with the NTN network entity is four symbols, the UE may exit the DRX sleep state up to four symbols early to transmit the CSI report.

Particular aspects of the subject matter described in this disclosure can be implemented to realize one or more of the following potential advantages. In some examples, by determining whether to transmit a periodic CSI report based on a logical symbol according to network timing and a timing offset while CSI masking is configured, the described techniques can be used to improve reliability of periodic CSI reporting and improve device coordination. For example, these techniques may enable a UE to transmit a periodic CSI report according to a timeline that is coherent with an NTN network entity, enabling the NTN network entity to receive the periodic CSI report and evaluate channel conditions.

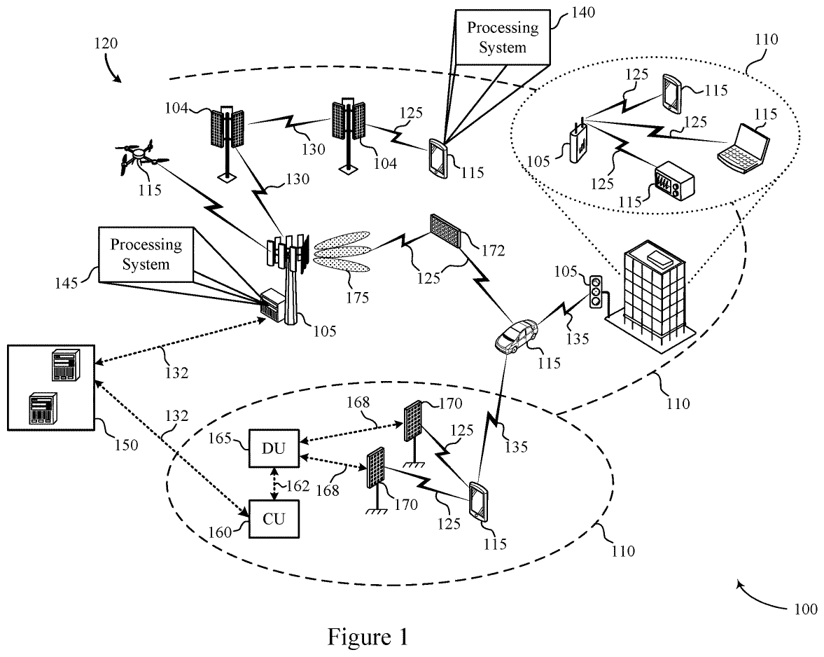

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration) or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a ULE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, CSI-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for periodic CSI reporting in an NTN. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support reduced power consumption and improved coordination between devices. For example, by determining whether to transmit a periodic CSI report based on a logical symbol according to network timing and a timing offset while CSI masking is configured, the described techniques can be used to improve reliability of periodic CSI reporting and improve device coordination. For example, these techniques may enable a UE to transmit a periodic CSI report according to a timeline that is coherent with an NTN network entity, enabling the NTN network entity to receive the periodic CSI report and evaluate channel conditions.

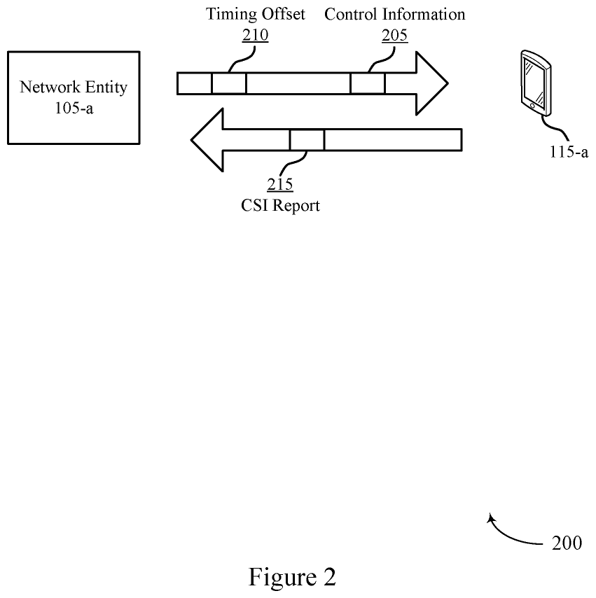

FIG. 2 shows an example of a signaling diagram 200 that supports periodic CSI reporting in an NTN. The signaling diagram 200 may implement aspects of a wireless communication system 100. For example, the signaling diagram 200 may include a UE 115-a and a network entity 105-b, which may be respective examples of a UE 115 and a network entity 105 described herein.

The network entity 105-a may be an example of an NTN network entity. For example, the network entity 105-a may be a satellite operating in orbit around Earth. Communications between the network entity 105-a and the UE 115-a may experience propagation delay, signaling may travel a large distance between the network entity 105-a and the UE 115-a. Due to the propagation delay, the UE 115-a may apply a timing adjustment when transmitting uplink signaling to the network entity 105-a. For example, the UE 115-a may begin uplink transmission early, before the start of a corresponding downlink frame at the UE, based on a timing adjustment of the UE 115-a. The timing adjustment may be based on a round trip time (RTT) between the UE 115-a and the network entity 105-a. Applying the timing adjustment may align uplink timing and downlink timing. For example, transmitting signaling in symbol i early by the timing adjustment may ensure the signaling arrives at the network entity 105-a in symbol i according to timing of the network entity 105-a.

The network entity 105-a may serve multiple UEs 115. The network entity 105-a may not be aware of positioning information for each UE 115, and may therefore not be aware of timing adjustments for each UE 115. To align network-side (e.g., downlink) and UE-side (e.g., uplink) timing, the network entity 105-a may schedule uplink communications based on a logical downlink slot, n, where a UE's transmitted uplink signal is supposed to arrive at the network entity 105-a.

In some examples, the UE 115-a may operate according to a DRX cycle. The UE 115-a may operate in a lower-power sleep state and wake up during an on-duration of the DRX cycle to perform communications (e.g., receive downlink control or data signaling or transmit uplink control or data signaling). In some examples, the network entity 105-a may transmit control information 205 to the UE 115-a to configure parameters for CSI reporting. In some examples, the control information may configure the UE 115-a for CSI masking, where the UE 115-a only reports CSI (e.g., transmits a CSI report) during an on-duration of a DRX cycle of the UE 115-a. For example, the control information may include a CSI reporting configuration, which may indicate resources (e.g., periodic resources) scheduled for a CSI report (e.g., a periodic CSI report). In some examples, the control information may be indicated via an RRC message, such as an RRC configuration message or an RRC reconfiguration message. The RRC message may, in some examples, configure the UE 115-a to operate according to the DRX cycle.

In some wireless communications systems, such as terrestrial networks, a UE 115 configured for CSI masking may determine whether to transmit a CSI report based on a current symbol, n. For example, if the current symbol n is within an on-duration of a DRX cycle the UE 115, and the UE 115 is scheduled to transmit a CSI report in the current symbol n, the UE 115 may transmit the CSI report. If the UE 115 is scheduled to transmit a CSI report in current symbol n, but current symbol n is not within the on-duration of the DRX cycle of the UE 115, the UE 115 may not transmit the CSI report.

In a terrestrial network, an RTT between a UE 115 and a network entity 105 (e.g., a terrestrial network entity) may be very small, such that a timing advance applied by the UE 115 is very small. This may enable the UE 115 to transmit the CSI report in current symbol n and for the CSI report to be received by the network entity 105 in the current symbol n. However, in an NTN, such as the NTN of the signaling diagram 200, a timing adjustment of a UE 115, such as the UE 115-a, may be larger, such that a CSI report transmitted in a current symbol is not received by an NTN network entity, such as the network entity 105-a, in the same symbol.

The signaling diagram 200 supports techniques for periodic CSI reporting in an NTN. The network entity 105-a may transmit, to the UE 115-a, an indication of a timing offset 210 for timing relationships that are associated with the NTN. In some examples, a parameter Koffset may be an example of the timing offset 210. In some cases, Koffset may correspond to a largest timing adjustment of a UE 115 in the NTN or a largest timing adjustment of a UE 115 served by the network entity 105-a. Additionally, or alternatively, the timing offset 210 may be associated with a timing adjustment of the UE 115-a. In some examples, the timing offset 210 may be denoted by TO_{UE}. A timing adjustment of the UE 115-a may correspond to a quantity of symbols, slots, or frames, denoted by TA_{UE}. In some examples, TO_{UE} and TA_{UE} may be the same. Additionally, or alternatively, TO_{UE} may correspond to Koffset.

The UE 115-a may be configured for periodic CSI reporting, and the network entity 105-a may expect to receive a CSI report 215 in a first symbol according to network-side timing. For example, the UE 115-a may be scheduled for the CSI report 215 in slot n, or the network entity 105-a may expect to receive the CSI report in slot n. The UE 115-a may evaluate whether to transmit a CSI report in a current symbol based on the symbol n and the timing offset 210.

For example, the symbol n may be after an on-duration of a DRX cycle of the UE 115-a ends. The UE 115-a may determine whether a symbol offset from the symbol n (e.g., by the timing offset 210 or a timing adjustment of the UE 115-a, or both) is within the on-duration of the DRX cycle of the UE 115-a. If a symbol n−TO_{UE} is in an active time of the UE 115-a or within the on-duration of the DRX cycle, the UE 115-a may transmit the CSI report 215 during the on-duration of the DRX cycle. The network entity 105-a may monitor for (e.g., expect to receive) the CSI report 215 in symbol n if symbol n−TO_{UE} is within the on-duration of the DRX cycle of the UE 115-a.

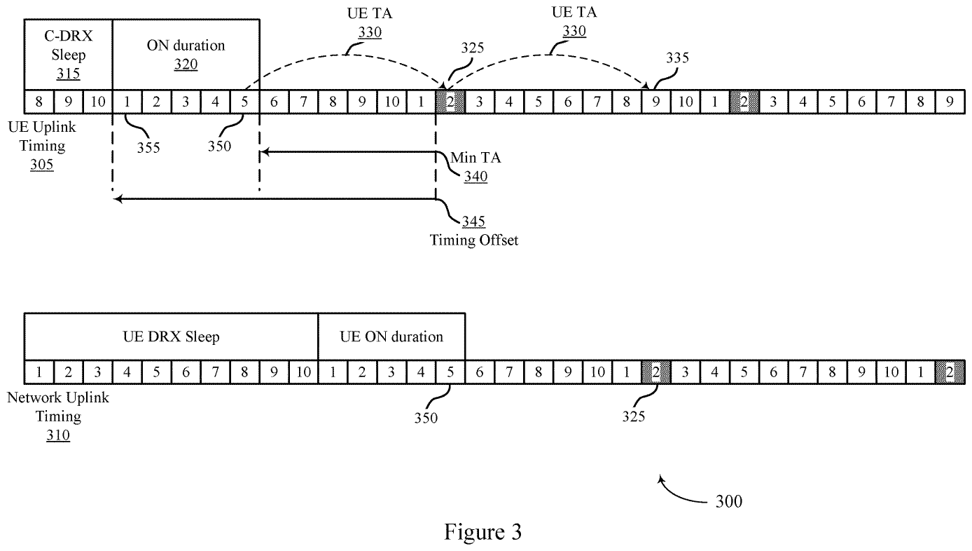

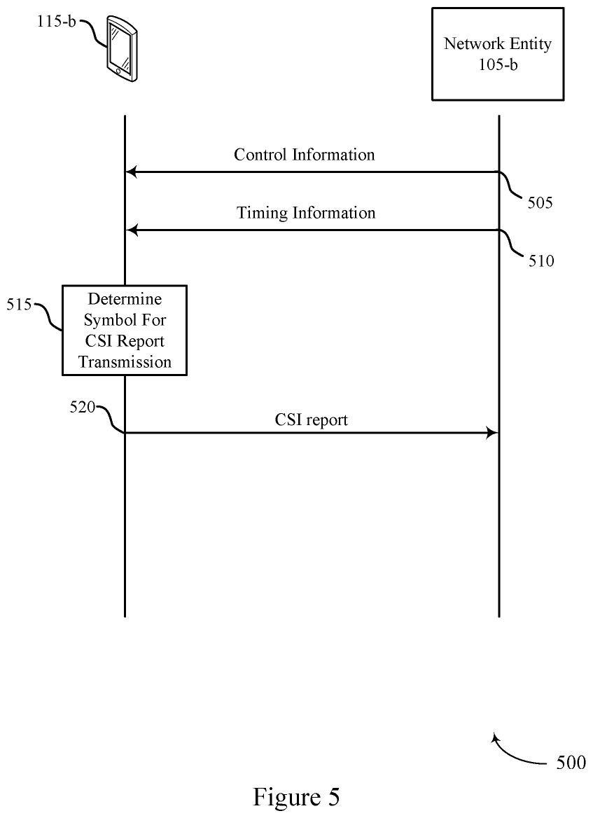

In some examples, timing between the network entity 105-a and the UE 115-a may be based on a timing offset Koffset. For example, the UE 115-a may be scheduled for the CSI report 215 in a symbol n+Koffset, or the network entity 105-a may expect to receive the CSI report 215 in symbol n+Koffset. If a symbol n+Koffset−TO_{UE} is in an active time or the on-duration of the DRX cycle of the UE 115 (e.g., if TO_{UE} is a timing adjustment of the UE 115-a), the UE 115-a may transmit the CSI report 215 in symbol n+Koffset−TO_{UE}. Some additional aspects for determining whether to transmit a CSI report based on a timing offset are described in more detail with reference to FIGS. 3 and 5.

In some examples, the UE 115-a may be scheduled for a CSI report 215 in a symbol n that occurs within an on-duration of the UE 115-a. For example, the network entity 105-a may expect to receive the CSI report 215 in the symbol n that occurs within the on-duration of the UE 115-a. In some examples, based on a timing adjustment of the UE 115-a, a symbol where the UE 115-a needs to transmit the CSI report 215 for the CSI report 215 to be received at the network entity 105-a in symbol n may be outside of the on-duration of the UE 115-a.

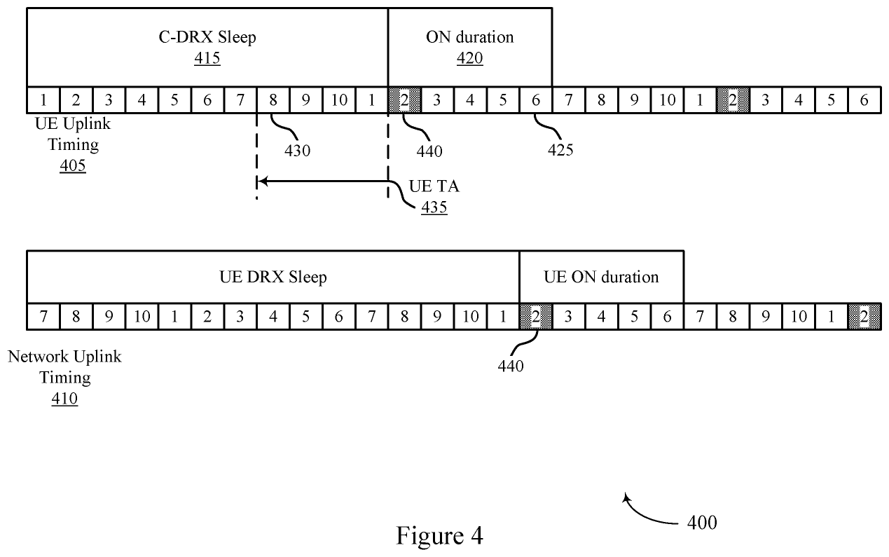

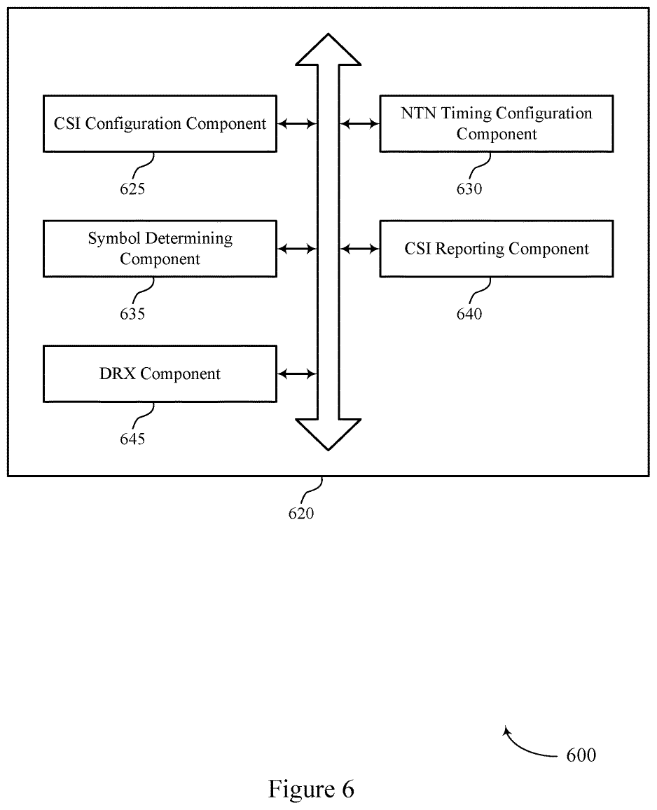

The signaling diagram 200 may support techniques for a UE 115, such as the UE 115-a, to wake up early from a DRX sleep state to transmit a CSI report 215. For example, if the symbol n occurs outside of the on-duration of the UE 115-a within a threshold quantity of symbols, the UE 115-a may wake up outside of the on-duration to transmit the CSI report 215. In some examples, the UE 115-a may wake up early from the on-duration by TA_{UE} to transmit the CSI report 215. For example, if symbol n is within the on-duration of the UE 115-a and symbol n−TA_{UE} falls outside of the on-duration, the UE 115-a may wake up prior to a start of the on-duration (e.g., exit a sleep state) to transmit the CSI report 215 in symbol n−TA_{UE}. Some additional aspects for determining whether to transmit a CSI report for a symbol that is within an on-duration of a DRX cycle are described in more detail with reference to FIGS. 4 and 6.

Some examples of timing offsets and timing adjustments described herein are described with reference to symbols. In some examples, timing offsets and timing adjustments may be in terms of slots or frames. For example, a timing adjustment of a UE 115 may correspond to a quantity of symbols, a quantity of slots, or a quantity of frames, or any combination thereof. Additionally, or alternatively, a timing offset (e.g., the timing offset 210 or Koffset) may be a quantity of symbols, a quantity of slots, or a quantity of frames, or any combination thereof. As used herein, the term “distance” when referring to symbols, timing relationships, or communication resources may refer to a temporal separation or duration between symbols, slots, frames, or other time-based communication elements. For example, a “threshold distance” between symbols may correspond to a duration of time (such as measured in milliseconds, microseconds, or other time units), a quantity of symbols (such as a number of symbol periods or symbol durations), a quantity of slots (such as a number of slot durations), a quantity of frames (such as a number of frame durations), or any combination thereof. The distance may represent a timing offset, timing adjustment, or other temporal relationship that accounts for propagation delays, processing delays, or synchronization requirements in wireless communication systems, including NTNs where such temporal separations may be relatively large due to signal propagation characteristics.

FIG. 3 shows an example of a CSI reporting timeline 300 that supports periodic CSI reporting in an NTN. The CSI reporting timeline 300 may implement, or be implemented by, aspects of a wireless communication system 100 or a signaling diagram 200.

The CSI reporting timeline 300 may include a UE uplink timing 305 and a network uplink timing 310. Network-side timing and UE-side timing may be offset by a duration of time that corresponds to a timing adjustment of a UE 115. In the example of FIG. 3, a UE 115 may have a timing adjustment 330 (“UE TA 330” of FIG. 3 and denoted by TA_{UE} herein) of seven symbols, such that an uplink signal transmitted in symbol 2 (e.g., of the UE uplink timing 305) is received at a network entity 105 (e.g., an NTN network entity) in symbol 9 (e.g., of the UE uplink timing 305).

The UE 115 may operate according to a DRX cycle. For example, the UE 115 may operate in a connected mode DRX (C-DRX) sleep state 315 until a start of an on-duration 320 of the DRX cycle. The UE 115 may be configured for periodic CSI reporting and to only transmit a periodic CSI report during the on-duration 320 (e.g., based on a CSI mask configuration).

For example, a symbol 325 may correspond to a periodic CSI reporting occasion. In some examples, the symbol 325 may correspond to symbol n described herein. The network entity 105 may expect to receive a CSI report in the symbol 325. Due to the timing adjustment 330 of the UE 115, if the UE 115 transmits the CSI report in the symbol 325, the CSI report may be received in a symbol 335 at the network entity 105.

The UE 115 may transmit the CSI report in a symbol based on the symbol n and a timing offset from the symbol n. For example, if symbol n−TA_{UE} is in the on-duration 320, the UE 115 may transmit the CSI report in symbol n−TA_{UE}. The network entity 105 may expect to receive the CSI report in symbol 325 (e.g., symbol n), and symbol 350 may offset from the symbol 325 by the timing adjustment 330 of the UE 115 (e.g., symbol n−TA_{UE}). The symbol 350 may be within the on-duration 320, and the UE 115 may transmit the CSI report in symbol 350. The CSI report, transmitted in symbol 325 by the UE 115, may be received at the network entity 105 in symbol 325 after a travel time corresponding to the timing adjustment 330.

In some examples, the network entity 105 may transmit timing offset information to the UE 115. The timing offset information may indicate a timing offset 345. In some examples, Koffset, or a largest timing advance of a UE 115 in an NTN served by the network entity 105, may be an example of the timing offset 345. The CSI reporting timeline may support techniques for CSI reporting based on Koffset.

The timing offset 345 may be configured by the network entity 105, such that the network entity 105 is aware of where a symbol that is offset from symbol n by the timing offset 345 is. For example, the network entity 105 may know where n−Koffset is. If a symbol n−Koffset is in an active time or occurs within the on-duration 320, the UE 115 may report CSI in the symbol n−Koffset. For example, symbol 325 may be symbol n, and a symbol 355 may corresponding to n−Koffset. The symbol 355 may be within the on-duration 320, so the network entity 105 may expect to receive the CSI report at symbol 325.

If a UE 115 has a small timing adjustment, a symbol where the UE 115 is to transmit the CSI report may be outside of the on-duration 320. In some examples, a UE 115 with a smaller timing adjustment than a minimum timing adjustment 340 may wake up outside of the on-duration 320 (e.g., after the on-duration 320 expires) to transmit the CSI report. In some examples, if the timing adjustment of the UE 115 is smaller than the minimum timing adjustment 340, the UE 115 may not transmit the CSI report. For example, both n−Koffset and n−Koffset+UE_{TA} may occur within the on-duration 320 for the UE 115 to transmit the CSI report in some examples.

The UE 115 may determine whether to transmit a CSI report in a current symbol. For example, if CSI masking is set up by upper layers (e.g., CSI masking is configured by RRC), in current symbol n−TA_{UE}, if an on-duration timer of a DRX cycle is not running considering grants or assignments scheduled on serving cells in the DRX group and a DRX command MAC CE or long DRX command MAC CE received until a threshold duration prior to symbol n−TA_{UE} when evaluating DRX active time conditions, and if in current symbol n−TA_{UE} point-to-multipoint DRX on-duration timers of all multicast DRX configurations corresponding to a DRX group are not running, the UE 115 may not transmit the CSI report. For example, unless symbol n−TA_{UE} corresponds to a symbol within an active time or the on-duration 320 of a DRX cycle, the UE 115 may not transmit the CSI report. If the symbol n−TA_{UE} does correspond to a symbol within an active time or the on-duration 320 of the DRX cycle, the UE 115 may transmit the CSI report. In some examples, in an NTN, a gap between a start of the on-duration 320 and a start of a CSI resource may be Koffset. The network entity 105 may configure the on-duration 320 and CSI resources (e.g., used to transmit a CSI report or a periodic CSI report) such that a gap between a start of the on-duration 320 (e.g., corresponding to symbol 355) and the CSI resource (e.g., corresponding to symbol 325) is Koffset.

FIG. 4 shows an example of a CSI reporting timeline 400 that supports periodic CSI reporting in an NTN. The CSI reporting timeline 400 may implement, or be implemented by, aspects of a wireless communication system 100, a signaling diagram 200, a CSI reporting timeline 300, or any combination thereof.

The CSI reporting timeline 400 may include a UE uplink timing 405 and a network uplink timing 410. Network-side timing and UE-side timing may be offset by a duration of time that corresponds to a timing adjustment of a UE 115, such as a timing adjustment 435 (“UE TA 435” of FIG. 4 and denoted by TA_{UE} herein). In the example of FIG. 4, the timing adjustment 435 of the UE 115 may be four symbols, such that an uplink signal transmitted in symbol 2 (e.g., of the UE uplink timing 405) is received at a network entity 105 (e.g., an NTN network entity) in symbol 6 (e.g., of the UE uplink timing 405).

The UE 115 may operate according to a DRX cycle. For example, the UE 115 may operate in a C-DRX sleep state 415 until a start of an on-duration 420 of the DRX cycle. The UE 115 may be configured for periodic CSI reporting and to only transmit a periodic CSI report during the on-duration 420 (e.g., based on a CSI mask configuration).

In some examples, the network entity 105 may schedule a CSI resource in the on-duration 420 of the UE 115. For example, symbol 440 (e.g., symbol n) may include a CSI resource for a periodic CSI report. The network entity 105 may expect to receive the periodic CSI report in the symbol 440. If the UE 115 transmits the CSI report in the symbol 440, the CSI report may be received by the network entity at a symbol 425 due to the timing adjustment 435 of the UE 115. To transmit the CSI report in time, the UE 115 may transmit the CSI report in a symbol offset from n. For example, if the UE 115 transmits the CSI report in symbol 430 (e.g., symbol n−TA_{UE}), the CSI report may arrive at the network entity 105 at symbol 440 (e.g., symbol n). However, the symbol 430 may be outside of the on-duration 420 of the UE 115.

In some examples, if a symbol n−TA_{UE} is outside of the on-duration 420 by a threshold duration, the UE 115 may transmit a CSI report in symbol n−TA_{UE}. For example, if symbol n−UE_{TA} occurs outside of a DRX on-duration timer duration by a maximum of 4 milliseconds, the network entity 105 may expect the UE 115 to transmit the CSI report such that the network entity 105 receives the CSI report at symbol n. In this example, the UE 115 may wake up from the C-DRX sleep state 415 a maximum of 4 milliseconds ahead of the on-duration 420 to transmit the CSI report. For example, the UE 115 may determine whether a first symbol (e.g., symbol n−TA_{UE}) satisfies a threshold distance away from a second symbol (e.g., symbol n) of the on-duration associated with a CSI report. If the first symbol satisfies the threshold distance away from the second symbol, the UE 115 may transmit the CSI report during the first symbol.

The threshold duration may be a quantity of symbols, a quantity of slots, or a quantity of frames, a quantity of milliseconds, or any combination thereof. In some examples, the timing adjustment 435 of the UE 115 may be a quantity of symbols, a quantity of slots, or a quantity of frames, a quantity of milliseconds, or any combination thereof. In some examples, the threshold duration may be based on (e.g., correspond to) the timing adjustment 435 of the UE 115 or Koffset (e.g., a largest timing adjustment of a UE 115 in the NTN).

If a UE 115 is to wake up more than the threshold duration ahead of the on-duration 420, the UE 115 may target another CSI resource. For example, the UE 115 may transmit the CSI report such that the CSI report is received by the network entity 105 via another CSI resource. In some other examples, the UE 115 may determine whether or not to wake up early to transmit the CSI report.

FIG. 5 shows an example of a process flow 500 that supports periodic CSI reporting in an NTN. The process flow 500 may implement, or be implemented by, aspects of a wireless communication system 100, a signaling diagram 200, a CSI reporting timeline 300, or a CSI reporting timeline 400, or any combination thereof. For example, the process flow 500 may be implemented by a UE 115-b or a network entity 105-b, or both. The UE 115-b may be an example of a UE 115 described herein, such as a UE 115 operating in an NTN. The network entity 105-b may be an example of a network entity 105 described herein, such as an NTN network entity (e.g., a satellite).

In the following description of the process flow 500, the operations between the UE 115-b and the network entity 105-b may occur in a different order than the example order shown and, in some examples, may be performed by one or more different devices other than those shown as examples. Some operations also may be omitted from the process flow 500, and other operations may be added to the process flow 500. Further, although some operations or signaling may be shown to occur at different times for discussion purposes, these operations may actually occur at the same time.

At 505, the network entity 105-b may transmit, and the UE 115-b may receive, control information. The control information may include CSI configuration information. For example, the CSI configuration information may indicate allocated resources for CSI reports. In some examples, the CSI configuration information may indicate a periodicity of the resources for CSI reports, such as for periodic CSI reporting. In some examples, the control information may indicate that CSI reports are communicated during an on-duration of a DRX cycle of the UE 115-b. For example, the control information may configure the UE 115-b for CSI masking, where the UE 115-b is to transmit a CSI report during the on-duration of the DRX cycle.

At 510, the network entity 105-b may transmit, and the UE 115-b may receive, timing information. For example, the UE 115-b may receive a timing offset for timing relationships that are associated with an NTN. In some examples, the timing information may include a value for Koffset, or a largest timing adjustment in the NTN. In some examples, the timing information include a value for a threshold duration for transmitting a CSI report outside of the on-duration of the DRX cycle.

In some examples, the control information and the timing information may be received via RRC. For example, an RRC configuration message or an RRC reconfiguration message may indicate the control information or the timing information, or both. In some examples, the RRC message, or a separate RRC message, may include configuration information for the DRX cycle of the UE 115-b.

At 515, the UE 115-b may determine a symbol for CSI report transmission. In some examples, the UE 115-b may determine whether to communicate a CSI report in a first symbol associated with the on-duration based on the control information and the timing offset. For example, the first symbol may be offset from a second symbol associated with the CSI report. For example, the CSI report may be scheduled for the second symbol, n, and the UE 115-b may determine whether to transmit the CSI report in a symbol that is offset from the second symbol. For example, the UE 115-b may determine to transmit a CSI report in a symbol n−TA_{UE}, or a symbol that is within the on-duration and offset from the symbol n by a timing adjustment of the UE 115-b. In some examples, if a symbol n−Koffset is within the on-duration of the DRX cycle of the UE 115-b, the network entity 105-b may expect to receive the CSI report in symbol n. For example, the UE 115-b may determine the symbol for CSI report transmission based on a determination that symbol n−Koffset is within the on-duration of the DRX cycle.

At 520, the UE 115-b may transmit the CSI report during the first symbol based on the determination. For example, the UE 115-b may transmit the CSI report during symbol n−TA_{UE} during the on duration. Based on the UE 115-b transmitting the CSI report during symbol n−TA_{UE}, the network entity 105-b may receive the CSI report in symbol n (e.g., as a signal carrying the CSI report experiences propagation delay from traveling to the network entity 105-b).

In some examples, the UE 115-b may determine whether a first symbol satisfies a threshold distance from a second symbol of the on-duration associated with a CSI report. For example, the CSI report may be scheduled for the second symbol, n, within the on-duration of a DRX cycle of the UE 115-b. The UE 115-b may determine whether the first symbol, for example n−TA_{UE}, satisfies a threshold distance from the second symbol. The first symbol may be outside of the on-duration of the DRX cycle. If, for example, the first symbol is within a threshold time difference (e.g., 4 milliseconds) of a start of the on-duration of the DRX cycle, the UE 115-b may transmit the CSI report in the first symbol. For example, at 520, the UE 115-b may transmit the CSI report during the first symbol based on the first symbol satisfying the threshold distance.

FIG. 6 shows an example of a processing system 620 that supports periodic CSI reporting in an NTN. A processing system 620 may be an example of a processing system 140 (such as of a UE 115) and may include a CSI configuration component 625, an NTN timing configuration component 630, a symbol determining component 635, a CSI reporting component 640, a DRX component 645, or any combination thereof. A processing system 620, or various component thereof, may be an example of means for performing (such as a means for causing a UE 115 to perform) various techniques described herein.

The CSI configuration component 625 may be configured to cause the UE 115 to receive control information indicating that CSI reports are communicated during an on-duration of a discontinuous reception cycle. The NTN timing configuration component 630 may be configured to cause the UE 115 to receive a timing offset for timing relationships that are associated with an NTN. The symbol determining component 635 may be configured to cause the UE 115 to determine whether to communicate a CSI report in a first symbol associated with the on-duration based on the control information and the timing offset, the first symbol being offset from a second symbol associated with the CSI report. The CSI reporting component 640 may be configured to cause the UE 115 to transmit the CSI report during the first symbol based on the determination.

In some examples, the timing offset corresponds to a largest timing adjustment in the NTN.

In some examples, the timing offset corresponds to a timing adjustment associated with the UE.

In some examples, the timing offset between the first symbol and the second symbol satisfies a first timing offset threshold associated with a minimum timing offset and a second timing offset threshold associated with a maximum timing offset.

In some examples, the timing offset is cell-specific, common to a set of multiple UEs including the UE, or specific to the UE.

In some examples, the CSI report is a periodic CSI report. In some examples, the second symbol corresponds to a reporting occasion for the periodic CSI report.

In some examples, to support receiving the control information, the CSI configuration component 625 may be configured to cause the UE 115 to receive a radio resource control signal that indicates the control information.

In some examples, to support determining whether to communicate the CSI report, the symbol determining component 635 may be configured to cause the UE 115 to determine whether the first symbol satisfies a threshold timing offset from the second symbol, where the channel state information report is transmitted based on the threshold timing offset being satisfied.

In some examples, to support receiving the timing offset, the NTN timing configuration component 630 may be configured to cause the UE 115 to receive a radio resource control signal including an NTN configuration including the timing offset for the timing relationships that are associated with the NTN.

In some examples, the control information includes CSI mask information.

In some examples, the CSI configuration component 625 may be configured to cause the UE 115 to receive control information indicating that CSI reports are communicated during an on-duration of a discontinuous reception cycle. In some examples, the NTN timing configuration component 630 may be configured to cause the UE 115 to receive a timing offset for timing relationships that are associated with an NTN. In some examples, the symbol determining component 635 may be configured to cause the UE 115 to determine whether a first symbol satisfies a threshold distance away from a second symbol of the on-duration associated with a CSI report based on the control information and the timing offset, the first symbol being offset from the second symbol. In some examples, the CSI reporting component 640 may be configured to cause the UE 115 to transmit the CSI report during the first symbol based on the first symbol satisfying the threshold distance.

In some examples, the DRX component 645 may be configured to cause the UE 115 to wake up prior to the on-duration based on a determination that the threshold distance is satisfied.

In some examples, the threshold distance corresponds to a timing adjustment of the UE. In some examples, the threshold distance is common to a set of multiple UEs including the UE, or the threshold distance is specific to the UE. In some examples, the threshold distance is a quantity of symbols, slots, or milliseconds.

In some examples, the CSI report is a periodic CSI report. In some examples, the second symbol corresponds to a reporting occasion for the periodic CSI report.

In some examples, the control information includes CSI mask information.

A processing system 620 may include or be a component of one or more chips, systems-on-chips (SoCs), chipsets, packages, components, or devices that individually or collectively constitute or include a processing system. A processing system 620 may interface with other components of a processing system 620. For example, operations described with reference to a processing system 620, or various components thereof, may be performed by or with other such components, including a receiver, a transmitter, a transceiver, a modem, a user interface, a modulator/demodulator, an encoder/decoder, or any combination thereof (such as of the processing system 620, coupled with the processing system 620, of a processing system 620).

By including or configuring a processing system 620 for operation in a processing system 620 as described herein, the processing system 620 may support techniques for reduced power consumption and more efficient utilization of communication resources.

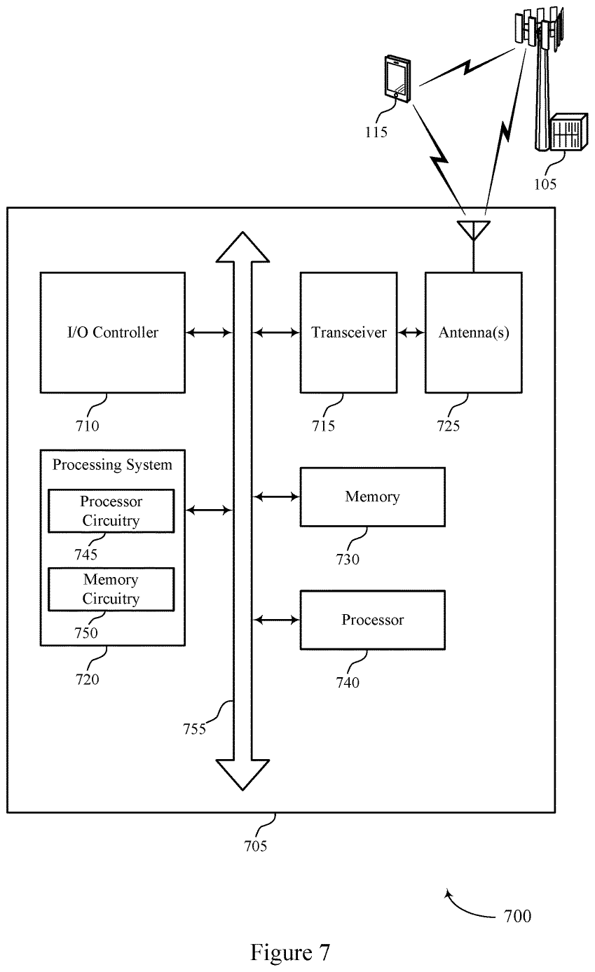

FIG. 7 shows an example of a system 700 including a device 705 that supports periodic CSI reporting in an NTN. The device 705 may be an example of or include components of UE 115. The device 705 may communicate (such as wirelessly) with one or more other devices (such as network entities 105, UEs 115). The device 705 may include components for transmitting and receiving communication, which may include a processing system 720, an input/output (I/O) controller, such as an I/O controller 710, a transceiver 715, antenna(s) 725, a memory 730, and a processor 740. Components of the device 705 may be coupled (such as operatively, communicatively, functionally, electronically, electrically, in electronic communication) a bus 755.

The transceiver 715 may support bi-directional communication via antenna(s) 725, and may support transmission operations, reception operations, or both, as described herein. The transceiver 715 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 705). The transceiver 715 may modulate symbols and provide the modulated symbols to antenna(s) 725 for transmission, and demodulate symbols from signals received using antenna(s) 725.

The processor 740 may be a general-purpose processing component that supports various operations (such as applications) of the device 705. The memory 730 may be a general-purpose storage component that stores code executable by the processor 740. Such code may include instructions that, when executed by the processor 740, cause the device 705 to perform various functions (such as to support an application of the device 705). The I/O controller 710 may manage inputs and outputs for the device 705, may manage peripherals not integrated into the device 705, or may represent a physical connection (such as port) to an external peripheral. The processor 740 may interact with a modem, a keyboard, a mouse, a touchscreen, or other device (such as via I/O controller 710). In some implementations, a user may interact with the device 705 via the I/O controller 710 or via hardware components controlled by the I/O controller 710.

The processing system 720 may be an example of a processing system 140 or a processing system 600. For example, the processing system 720 may include processor circuitry 745 and memory circuitry 750 that stores code, and may be configured to cause the device 705 to perform operations that support periodic CSI reporting in an NTN. Although the processing system 720 is illustrated as a separate component, which may involve a separate chip, chipset, or other module, in some implementations, one or more functions described with reference to the processing system 720 may be supported by or performed by a transceiver 715, antenna(s) 725, a processor 740, memory 730, or any combination thereof, such that a processing system 720 may include one or more of a transceiver 715, antenna(s) 725, a processor 740, memory 730, or any combination thereof.

By including or configuring the processing system 720 for operation in the device 705 as described herein, may support techniques for improved communication reliability, reduced latency, more efficient utilization of communication resources, and improved coordination between devices.

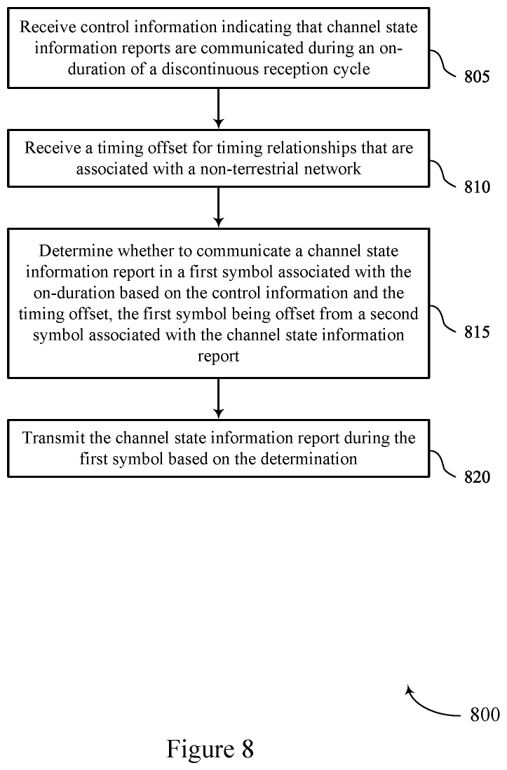

FIG. 8 shows an example of a method 800 that supports periodic CSI reporting in an NTN. Operations of the method 800 may be performed by a UE or its components (such as using a processing system configured to cause the UE 115 to perform one or more of the operations) as described herein.

At 805, the method may include receiving control information indicating that CSI reports are communicated during an on-duration of a discontinuous reception cycle. In some examples, aspects of the operations of 805 may be performed by a CSI configuration component 625.

At 810, the method may include receiving a timing offset for timing relationships that are associated with an NTN. In some examples, aspects of the operations of 810 may be performed by an NTN timing configuration component 630.

At 815, the method may include determining whether to communicate a CSI report in a first symbol associated with the on-duration based on the control information and the timing offset, the first symbol being offset from a second symbol associated with the CSI report. In some examples, aspects of the operations of 815 may be performed by a symbol determining component 635.

At 820, the method may include transmitting the CSI report during the first symbol based on the determination. In some examples, aspects of the operations of 820 may be performed by a CSI reporting component 640.

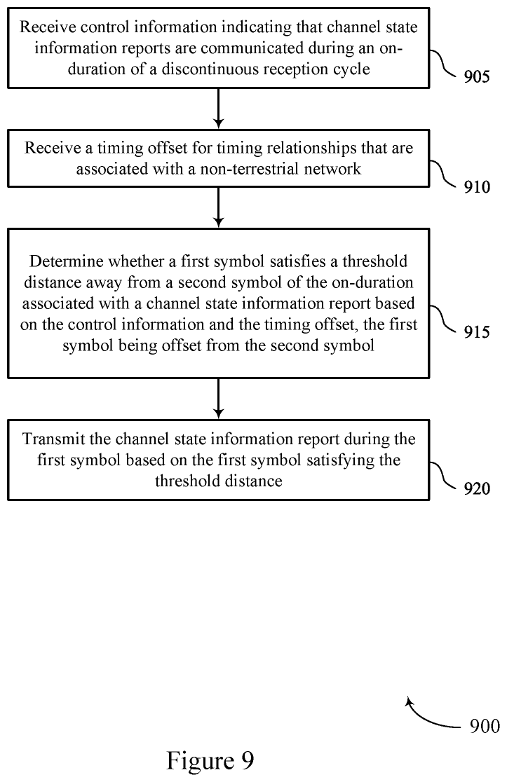

FIG. 9 shows an example of a method 900 that supports periodic CSI reporting in an NTN. Operations of the method 900 may be performed by a UE or its components (such as using a processing system configured to cause the UE 115 to perform one or more of the operations) as described herein.

At 905, the method may include receiving control information indicating that CSI reports are communicated during an on-duration of a discontinuous reception cycle. In some examples, aspects of the operations of 905 may be performed by a CSI configuration component 625.

At 910, the method may include receiving a timing offset for timing relationships that are associated with an NTN. In some examples, aspects of the operations of 910 may be performed by an NTN timing configuration component 630.

At 915, the method may include determining whether a first symbol satisfies a threshold distance away from a second symbol of the on-duration associated with a CSI report based on the control information and the timing offset, the first symbol being offset from the second symbol. In some examples, aspects of the operations of 915 may be performed by a symbol determining component 635.

At 920, the method may include transmitting the CSI report during the first symbol based on the first symbol satisfying the threshold distance. In some examples, aspects of the operations of 920 may be performed by a CSI reporting component 640.

Implementation examples are described in the following numbered clauses:

Aspect 1: A method for wireless communications at a UE, comprising: receiving control information indicating that CSI reports are communicated during an on-duration of a discontinuous reception cycle; receiving a timing offset for timing relationships that are associated with an NTN; determining whether to communicate a CSI report in a first symbol associated with the on-duration based at least in part on the control information and the timing offset, the first symbol being offset from a second symbol associated with the CSI report; and transmitting the CSI report during the first symbol based at least in part on the determination.

Aspect 2: The method of aspect 1, wherein the timing offset corresponds to a largest timing adjustment in the NTN.

Aspect 3: The method of any of aspects 1 through 2, wherein the timing offset corresponds to a timing adjustment associated with the UE.

Aspect 4: The method of any of aspects 1 through 3, wherein the timing offset between the first symbol and the second symbol satisfies a first timing offset threshold associated with a minimum timing offset and a second timing offset threshold associated with a maximum timing offset.

Aspect 5: The method of any of aspects 1 through 4, wherein the timing offset is cell-specific, common to a plurality of UEs including the UE, or specific to the UE.

Aspect 6: The method of any of aspects 1 through 5, wherein the CSI report is a periodic CSI report, and the second symbol corresponds to a reporting occasion for the periodic CSI report.

Aspect 7: The method of any of aspects 1 through 6, wherein receiving the control information comprises: receiving a radio resource control signal that indicates the control information.

Aspect 8: The method of any of aspects 1 through 7, wherein receiving the timing offset comprises: receiving a radio resource control signal including an NTN configuration comprising the timing offset for the timing relationships that are associated with the NTN.

Aspect 9: The method of any of aspects 1 through 8, wherein the control information comprises CSI mask information.

Aspect 10: A method for wireless communications at a UE, comprising: receiving control information indicating that CSI reports are communicated during an on-duration of a discontinuous reception cycle; receiving a timing offset for timing relationships that are associated with an NTN; determining whether a first symbol satisfies a threshold distance away from a second symbol of the on-duration associated with a CSI report based at least in part on the control information and the timing offset, the first symbol being offset from the second symbol; and transmitting the CSI report during the first symbol based at least in part on the first symbol satisfying the threshold distance.

Aspect 11: The method of aspect 10, further comprising: waking up prior to the on-duration based at least in part on a determination that the threshold distance is satisfied.

Aspect 12: The method of any of aspects 10 through 11, wherein the threshold distance corresponds to a timing adjustment of the UE.

Aspect 13: The method of any of aspects 10 through 12, wherein the threshold distance is common to a plurality of UEs including the UE, or the threshold distance is specific to the UE.

Aspect 14: The method of any of aspects 10 through 13, wherein the threshold distance is a quantity of symbols, slots, or milliseconds.

Aspect 15: The method of any of aspects 10 through 14, wherein the CSI report is a periodic CSI report, and the second symbol corresponds to a reporting occasion for the periodic CSI report.

Aspect 16: The method of any of aspects 10 through 15, wherein the control information comprises CSI mask information.

Aspect 17: A UE for wireless communications, comprising a processing system that includes processor circuitry and memory circuitry that stores code, the processing system configured to cause the UE to perform a method of any of aspects 1 through 9.

Aspect 18: A UE for wireless communications, comprising at least one means for performing a method of any of aspects 1 through 9.

Aspect 19: A non-transitory computer-readable medium storing code for wireless communications, the code comprising instructions executable by one or more processors to perform a method of any of aspects 1 through 9.

Aspect 20: A UE for wireless communications, comprising a processing system that includes processor circuitry and memory circuitry that stores code, the processing system configured to cause the UE to perform a method of any of aspects 10 through 16.

Aspect 21: A UE for wireless communications, comprising at least one means for performing a method of any of aspects 10 through 16.

Aspect 22: A non-transitory computer-readable medium storing code for wireless communications, the code comprising instructions executable by one or more processors to perform a method of any of aspects 10 through 16.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
a processing system that includes processor circuitry and memory circuitry that stores code, the processing system configured to cause the UE to:
receive control information indicating that channel state information reports are communicated during an on-duration of a discontinuous reception cycle;
receive a timing offset for timing relationships that are associated with a non-terrestrial network;
determine whether to communicate a channel state information report in a first symbol associated with the on-duration based at least in part on the control information and the timing offset, the first symbol being offset from a second symbol associated with the channel state information report; and
transmit the channel state information report during the first symbol based at least in part on the determination.

2. The UE of claim 1, wherein determining whether to communicate the channel state information report comprises:
determining whether the first symbol satisfies a threshold timing offset from the second symbol, wherein the channel state information report is transmitted based on the threshold timing offset being satisfied.

3. The UE of claim 1, wherein the timing offset corresponds to a largest timing adjustment in the non-terrestrial network.

4. The UE of claim 1, wherein the timing offset corresponds to a timing adjustment associated with the UE.

5. The UE of claim 1, wherein the timing offset between the first symbol and the second symbol satisfies a first timing offset threshold associated with a minimum timing offset and a second timing offset threshold associated with a maximum timing offset.

6. The UE of claim 1, wherein the timing offset is cell-specific, common to a plurality of UEs including the UE, or specific to the UE.

7. The UE of claim 1, wherein:
the channel state information report is a periodic channel state information report, and
the second symbol corresponds to a reporting occasion for the periodic channel state information report.

8. The UE of claim 1, wherein, to receive the control information, the processing system is configured to cause the UE to:
receive a radio resource control signal that indicates the control information.

9. The UE of claim 1, wherein, to receive the timing offset, the processing system is configured to cause the UE to:
receive a radio resource control signal comprising a non-terrestrial network configuration comprising the timing offset for the timing relationships that are associated with the non-terrestrial network.

10. The UE of claim 1, wherein:
the control information comprises channel state information mask information.

11. A user equipment (UE), comprising:
a processing system that includes processor circuitry and memory circuitry that stores code, the processing system configured to cause the UE to:
receive control information indicating that channel state information reports are communicated during an on-duration of a discontinuous reception cycle;
receive a timing offset for timing relationships that are associated with a non-terrestrial network;
determine whether a first symbol satisfies a threshold distance away from a second symbol of the on-duration associated with a channel state information report based at least in part on the control information and the timing offset, the first symbol being offset from the second symbol; and
transmit the channel state information report during the first symbol based at least in part on the first symbol satisfying the threshold distance.

12. The UE of claim 11, wherein the processing system is further configured to cause the UE to:
wake up prior to the on-duration based at least in part on a determination that the threshold distance is satisfied.

13. The UE of claim 11, wherein the threshold distance corresponds to a timing adjustment of the UE.

14. The UE of claim 11, wherein the threshold distance is common to a plurality of UEs including the UE, or the threshold distance is specific to the UE.

15. The UE of claim 11, wherein the threshold distance is a quantity of symbols, slots, or milliseconds.

16. The UE of claim 11, wherein:
the channel state information report is a periodic channel state information report, and
the second symbol corresponds to a reporting occasion for the periodic channel state information report.

17. The UE of claim 11, wherein:
the control information comprises channel state information mask information.

18. A method for wireless communications at a user equipment (UE), comprising:
receiving control information indicating that channel state information reports are communicated during an on-duration of a discontinuous reception cycle;
receiving a timing offset for timing relationships that are associated with a non-terrestrial network;
determining whether to communicate a channel state information report in a first symbol associated with the on-duration based at least in part on the control information and the timing offset, the first symbol being offset from a second symbol associated with the channel state information report; and
transmitting the channel state information report during the first symbol based at least in part on the determination.

19. The method of claim 18, wherein the timing offset corresponds to a largest timing adjustment in the non-terrestrial network or a timing adjustment associated with the UE.

20. The method of claim 18, wherein the timing offset between the first symbol and the second symbol satisfies a first timing offset threshold associated with a minimum timing offset and a second timing offset threshold associated with a maximum timing offset.
